(19) United States
(12) Patent Application Publication
(10) Pub. No.: US 2023/0279212 A1
(43) Pub. Date: Sep. 7, 2023

(54) ACRYLIC COPOLYMER RESINS

(71) Applicant: Trinseo Europe GmbH, Horgen (CH)

(72) Inventor: Jiaxin Jason Ge, Audubon, PA (US)

(73) Assignee: Trinseo Europe GmbH, Horgen (CH)

(21) Appl. No.: 17/687,222

(22) Filed: Mar. 4, 2022

(51) Int. Cl. C08L 33/12; C08F 220/18

(52) U.S. Cl. CPC C08L 33/12; C08F 220/1811; C08L 2201/10; C08L 2207/53

(57) ABSTRACT

Acrylic copolymers incorporating high Tg, hydrophobic (meth)acrylate monomers that have high thermal stability, especially under hot, humid conditions are provided. The acrylic copolymer includes, as polymerized monomers, a combination of monomer a) and monomer b). Monomer a) includes at least one of tert-butyl cyclohexyl (meth)acrylate, 3,3,5-trimethyl cyclohexyl (meth)acrylate, or a mixture thereof. This monomer or monomer blend a) is present in the acrylic copolymer at from 0.2 to 20 weight percent and includes at least 80 weight % trans isomer. Monomer b) is (meth)acrylate and is present in the acrylic copolymer at from 80 to 99.8 weight percent of the acrylic copolymer. The acrylic copolymer has a Tg of from 116° C. to 145° C. and a weight average molecular weight (Mw) of at least 65,000 g/mole.

### FIELD OF THE INVENTION

The invention relates to acrylic copolymers incorporating high Tg, hydrophobic (meth)acrylates and derivatives that have high thermal stability, especially under hot, humid conditions.

### BACKGROUND OF THE INVENTION

Thermoplastic polymers and copolymers, especially (meth)acrylic polymers, have characteristics such as transparency, mechanical properties and processability and are widely used in various fields such as automobile parts, electrical parts, industrial parts, optical materials, various parts of household electrical appliances, medical devices, signage, aesthetical parts, miscellaneous goods and the like.

High Tg acrylic polymers may be useful in applications requiring a high optical clarity and high heat resistance, such as automotive front inner lenses, thin wall parts, lighting pipes, optical protection/retardation films in electronic devices, solar lenses/films, home appliance, composites, and others. It is expected the market for high heat acrylic copolymers in automotive LED front inner lenses and interior thin lenses will rapidly increase. In addition, high heat acrylic films are also used in LED/OLED displays. Standard polymethylmethacrylate (pMMA) copolymers, however, may lack the ability to pass demanding long-term environmental stability tests such as 80° C./85% relative humidity (RH) and/or 85° C./85% RH test requirements for automotive front inner thick lenses, automotive interior inner lenses, thin wall parts/lenses, solar transparent panels/lenses, and new optical films in electronics and smartphones. These applications generally require a combination of high glass transition temperature (Tg) and a hydrophobic character. Most high Tg monomers, such as methacrylic acid and/or maleic anhydride, are hydrophilic, and their copolymers are not resistant to moisture.

High Tg acrylic copolymers, such as methyl methacrylate/methacrylic acid copolymer are described in US 2018-0362688.

U.S. Pat. No. 10,043,930 describes high Tg acrylic copolymers, using a variety of high Tg comonomers, for use in photovoltaic front sheets.

### SUMMARY OF THE INVENTION

The present invention has demonstrated that incorporating relatively low amounts of high trans:cis ratio of certain cyclohexyl containing comonomers into pMMA increases hydrophobicity to acrylic copolymers/terpolymers, while maintaining high Tg/Vicat softening temperature and sufficiently high molecular weights for the aforementioned challenging market applications.

An acrylic copolymer comprising, consisting of, or consisting essentially of, as polymerized monomers, a combination of monomer a) and monomer b) is provided. Monomer a) comprises, consists of or consists essentially of at least one of tert-butyl cyclohexyl (meth)acrylate, 3,3,5-trimethyl cyclohexyl (meth)acrylate, or a mixture thereof. This monomer is present in the acrylic copolymer at from 0.2 to 20 weight percent, and preferably from 0.5 to 10 weight percent of monomer units in the acrylic copolymer. The monomer a) comprises, consists of or consists essentially of at least 80 weight %, more preferably at least 85 weight %, and most preferably at least 90 weight % trans isomer. Monomer b) is (meth)acrylate monomer units and is present in the acrylic copolymer at from b) from 80 to 99.8 weight percent of the total monomer units. The acrylic copolymer has: i) a Tg of from 116° C. to 145° C., preferably from 120° C. to 145° C., more preferably from 125° C. to 145° C., and most preferably from 125° C. to 140° C.; and ii) a weight average molecular weight (Mw) of at least 65,000 g/mole, preferably at least 75,000 g/mole, and more preferably at least 90,000 g/mole and most preferably at least 100,000 g/mol.

### DETAILED DESCRIPTION

“Copolymer” is used to mean a polymer having two or more different monomer units, including copolymers, and polymers with three or more different monomers, such as terpolymers and tetrapolymers. Accordingly, the terms “co-, ter- and tetra-polymer” encompass any polymer having more than one type of comonomer. “Polymer” is used to mean both homopolymer and copolymers. Polymers may be straight chain, branched, star, comb, block, or any other structure. The polymers may be homogeneous, heterogeneous, and may have a gradient distribution of co-monomer units. All references cited are incorporated herein by reference. As used herein, unless otherwise described, percent shall mean weight percent. Molecular weight is a weight average molecular weight as measured by gel permeation chromatography (GPC) using polymethylmethacrylate standards. In cases where the polymer contains some cross-linking, and GPC cannot be applied due to an insoluble polymer fraction, soluble fraction/gel fraction or soluble faction molecular weight after extraction from gel is used to determine weight average molecular weight.

By “hydrophobic” as used herein means that PMMA copolymers contain at least 0.2 weight. % of tert-butyl cyclohexyl (meth)acrylate and/or 3,3,5-trimethyl cyclohexyl (meth)acrylate hydrophobic monomer units.

By “(meth)acrylic” or “(meth)acrylate” as used herein denotes both the acrylate and the methacrylate.

In one embodiment, the hydrophobic copolymer of the invention passes an 85° C./85% RH test. In another embodiment, the hydrophobic copolymer of the invention passes a −40° C. to 80° C./85% RH humidity freeze cycling test.

The inventors have prepared copolymers incorporating hydrophobic tert-butyl cyclohexyl (meth)acrylate monomer (with a trans/cis isomer ratio of 80/20 or more) and/or 3,3,5-trimethyl cyclohexyl (meth)acrylate (with a trans/cis isomer ratio of 80/20 or more) monomer into acrylic copolymers, ter-polymers, and tetra-polymers with sufficiently high Tg and high molecular weight to form hydrophobic, high heat-resistant acrylic articles for use in automotive LED front thick lenses, auto interior thin lenses, LED lighting pipes, optical films for LCD/OLED devices and smartphones, optical imaging lenses, solar transparent lenses, and other applications requiring a combination of resistance to high-humidity and high temperature conditions. These new hydrophobic high heat acrylic materials are designed to meet the requirement of high light transmission in the visible wavelength region, low haze, high heat resistance, low water/moisture uptake, environmental stability, and sufficient mechanical properties, optionally with excellent UV resistance. Hydrophobic high Tg copolymers or terpolymers (with the refractive index of 1.47-1.50) are physically compatible with selected high molecular and optical acrylic copolymers as mixtures (blends) and/or combinations through melt processing/solution blending methods. The weight percentage of hydrophobic high heat copolymers (containing tert-butyl cyclohexyl methacrylate) used in homo-polymer and copolymer blends may range from 10% to 90% by weight of the total composition. The optical protection optical properties of these copolymers or compositions thereof possess light transmission of higher than 91%, optical haze of less than 2%, preferably less than 0.5%. The copolymers and blends thereof have high Tg, excellent thermal stability, low water/moisture absorption, excellent mechanical properties, and excellent environmental stability as evidenced by passing testing protocols at −40° C. to 80° C./85% RH humidity freeze cycling and/or 85° C./85% RH.

The high heat-resistant pMMA materials containing hydrophobic tert-butyl cyclohexyl methacrylate and/or 3,3,5-trimethyl cyclohexyl (meth)acrylate are capable of and/or characterized by high heat resistance, high light transmission, low haze, low water/moisture uptake, environmental stability. These materials also have excellent mechanical properties, along with excellent UV resistance.

These optical grade resins may be made by processes such as, but not limited to melt polymerization, solution polymerization, emulsion polymerization, and suspension polymerization.

Optical films and/or sheets made from or compromising, consisting or consisting essentially of the inventive copolymer may have a light transmission of higher than 91%, and/or an optical haze of less than 2.5%.

This invention is related to structure-property relationships in optical hydrophobic high heat-resistant acrylic copolymers/terpolymers potential for applications in automotive LED front inner thick lenses, auto interior thin lenses, auto LED lighting pipes, optical protection/retardation films in LCD/OLED electronic devices, solar transparent panels/lenses, home appliances (e.g., dishwashers), medical devices, composites, and other applications. In addition, these high heat-resistant pMMA copolymers have also been used thin wall parts such as exterior optical lenses and instrumental panels. If energy saving OLED technologies are widely used, the areas of optical polarization films for OLED will be increased, depending on the volume. Other applications may include digital printing for signage, film in-mold decoration, surface protection films, medical devices, Li-ion battery binders, window profiles, and even co-extrusion applications.

### Tert-Butyl Cyclohexyl Methacrylate

Tert-butyl cyclohexyl (meth)acrylate has the structural formulas below:

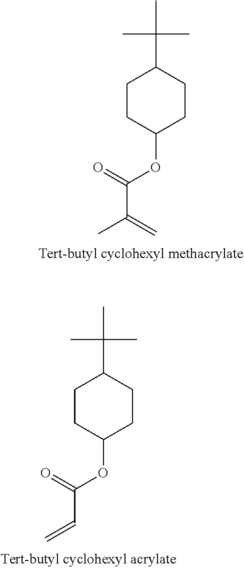 [SMILES: C=C(C)C(=O)OC1CCC(C(C)(C)C)CC1 ; C=CC(=O)OC1CCC(C(C)(C)C)CC1]

The monomer tert-butyl cyclohexyl l(meth)acrylate is a mixture of the cis- and trans-forms with respect to the cyclohexyl group. The ratio of the cis and trans isomers has surprisingly been found to have an effect on the resulting heat and humidity resistance of the resulting copolymers. In order to provide the high Tg copolymers, the tert-butyl cyclohexyl (meth)acrylate monomer comprises, consists of or consists essentially of least 80 weight %, more preferably at least 85 weight %, and most preferably at least 90 weight % trans isomer. The tert-butyl cyclohexyl (meth)acrylate may comprise, consist of or consist essentially of at least 81, 82, 83, 84, 86, 87, 88, 89, 91, 92, 93, 94, 95, 96, or 97 weight % of the trans isomer by weight of the tert-butyl cyclohexyl (meth)acrylate monomer.

The level of tert-butyl cyclohexyl (meth)acrylate in the final copolymer may be from 0.2 to 20 weight percent, and more preferably from 0.5 to 10 weight percent of tert-butyl cyclohexyl (meth)acrylate in the copolymer, based on the weight of the copolymer. It has been found that as little as 1 weight percent, and even 0.5 weight percent tert-butyl cyclohexyl (meth)acrylate, provides a copolymer having a hydrophobic character, while also providing sufficiently high Tg to pass rigorous high humidity, high heat testing protocols. For example such copolymers may comprise from 0.2 to 15, 0.3 to 15, 0.4 to 10, 0.5 to 9, 0.6 to 8, 0.7 to 7, 0.8 to 6, 0.9 to 5, 1 to 5, 1 to 6, 1 to 7, 1 to 8, 1 to 10, 3 to 10, 5 to 20, 5 to 15, 10 to 15, 10 to 20, 5 to 10, 0.2 to 10, 0.2 to 15, 0.2 to 8, 0.2 to 5, 0.5 to 15, 1 to 10, 1 to 5, 10 to 15, or 5 to 15 weight percent of tert-butyl cyclohexyl (meth)acrylate in the final copolymer.

### 3,3,5-trimethylcyclohexyl(meth)acrylate 3,3,5-trimethylcyclohexyl(meth)acrylate is a mixture of the cis- and trans- forms (with respect to the cyclohexyl group) and has the structural formulas below:

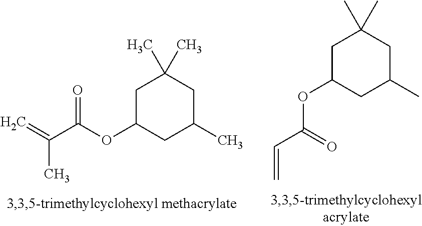

The monomer 3,3,5-trimethylcyclohexyl(meth)acrylate is a mixture of the cis- and trans- forms with respect to the cyclohexyl group. The ratio of the cis and trans isomers has surprisingly been found to have an effect on the resulting heat and humidity resistance of the resulting copolymers. In order to provide the high Tg copolymers, the 3,3,5-trimethylcyclohexyl(meth)acrylate comprises, consists of or consists essentially of least 80 weight %, more preferably at least 85 weight %, and most preferably at least 90 weight % trans isomer. The 3,3,5-trimethylcyclohexyl(meth)acrylate monomer may comprise, consist of or consist essentially of at least 81, 82, 83, 84, 86, 87, 88, 89, 91, 92, 93, 94, 95, 96, or 97 weight % of the trans isomer by weight of the 3,3,5-trimethylcyclohexyl(meth)acrylate monomer.

The level of 3,3,5-trimethylcyclohexyl(meth)acrylate in the final copolymer generally ranges from 0.2 to 20 weight percent, and more preferably from 0.5 to 10 weight percent of 3,3,5-trimethylcyclohexyl(meth)acrylate is used in the copolymer. It has been found that as little as 1 weight percent, and even 0.5 weight percent 3,3,5-trimethylcyclohexyl(meth)acrylate monomer, provides a copolymer having a hydrophobic character, while also providing sufficiently high Tg to pass rigorous high humidity, high heat testing protocols. For example such copolymers may comprise from 0.2 to 15, 0.3 to 15, 0.4 to 10, 0.5 to 9, 0.6 to 8, 0.7 to 7, 0.8 to 6, 0.9 to 5, 1 to 5, 1 to 6, 1 to 7, 1 to 8, 1 to 10, 3 to 10, 5 to 20, 5 to 15, 10 to 15, 10 to 20, 5 to 10, 0.2 to 10, 0.2 to 15, 0.2 to 8, 0.2 to 5, 0.5 to 15, 1 to 10, 1 to 5, 10 to 15, or 5 to 15 weight percent of 3,3,5-trimethylcyclohexyl(meth)acrylate monomer in the final copolymer.

Blends of 3,3,5-trimethylcyclohexyl(meth)acrylate monomer and tert-butyl cyclohexyl (meth)acrylate may be used to form the inventive copolymers. The monomer blend may comprises, consist of or consist essentially of from 1 to 100 weight percent of 3,3,5-trimethylcyclohexyl(meth)acrylate monomer and from 100 to 1 weight percent of tert-butyl cyclohexyl (meth)acrylate.

In order to provide the high Tg copolymers, the blend of these monomers comprises, consists of or consists essentially of least 80 weight %, more preferably at least 85 weight %, and most preferably at least 90 weight % trans isomer. The monomer blend may comprise, consist of or consist essentially of at least 81, 82, 83, 84, 86, 87, 88, 89, 91, 92, 93, 94, 95, 96, or 97 weight % of the trans isomers by weight of the monomer blend.

The level of the blend of monomers in the final copolymer generally ranges from 0.2 to 20 weight percent, and more preferably from 0.5 to 10 weight percent the monomer blend may be present in the copolymer. It has been found that as little as 1 weight percent, and even 0.5 weight percent of the monomer blend, provides a copolymer having a hydrophobic character, while also providing sufficiently high Tg to pass rigorous high humidity, high heat testing protocols. For example such copolymers may comprise from 0.2 to 15, 0.3 to 15, 0.4 to 10, 0.5 to 9, 0.6 to 8, 0.7 to 7, 0.8 to 6, 0.9 to 5, 1 to 5, 1.5 to 5, 1 to 6, 1 to 7, 1 to 8, 1 to 10, 3 to 10, 5 to 20, 5 to 15, 10 to 15, 10 to 20, 5 to 10, 0.2 to 10, 0.2 to 15, 0.2 to 8, 0.2 to 5, 0.5 to 15, 1 to 10, 1 to 5, 10 to 15, or 5 to 15 weight percent of the monomer blend in the final copolymer.

According to an embodiment, the copolymer including trimethylcyclohexyl(meth)acrylate and/or tert-butyl cyclohexyl (meth)acrylate may have a syndiotacticity (rr) of at least 50% of the copolymer, more preferably at least 55% and most preferably at least 60%, as measured by the method described in the Examples. The syndiotacticity (rr) of the copolymer may be at least 51, 52, 53, 54, 55, 56, 57, 58, 59, 61, 62, 63, 64, 65, 66, 67, 68, 69, 70, 71, 72, 73, 74, 75, 76, 77, 78, 79, or 80%.

The inventive co-, ter- or tetra-polymers may have a refractive index of from 1.47 to 1.50 at the wavelength of 589 nm. These materials may also have a haze value of less than 2.5%, more preferably less than 1.5% and most preferably less than 0.5%. The haze value of the copolymers may be less than 2.4, 2.3, 2.2, 2.1, 2.0, 1.9, 1.8, 1.7, 1.6, 1.4, 1.3, 1.2, 1.1, 1.0, 0.9, 0.8, 0.8, 0.6, 0.4, 0.3, or 0.2% as measured using the methods described in the Examples.

The co-, ter- or tetra-polymer may have a light transmission value at 560 nm wavelength through a 120 μm film of at least 91%, more preferably at least 91.5% and most preferably at least 92%. The co-, ter- or tetra-polymer may have a refractive index of from 1.47 to 1.50 at 589 nm wavelength. The co-, ter- or tetra-polymer may have a water absorption of less than 2 weight %, preferably less than 1.5 weight % and most preferably less than 1.3 weight % after at least 504 hours in 60° C. water. The water absorption may less than 1.9, 1.8, 1.7, 1.6, 1.4, 1.3, 1.2, 1.1 or less than 1 weight % after at least 504 hours in 60° C. water. According to an embodiment, 3.2 mm thick samples of the co-, ter- or tetra-polymer may have no visible stress crazing or cracking defects after 600 hours of exposure to 75 cycles of −40° C. to 80° C./85% RH.

### Acrylic Monomers, Methyl Methacrylate (MMA)

One or more of the hydrophobic, high Tg monomers, is copolymerized with one or more other monomers. In a preferred embodiment of the invention, the copolymer contains at least 50 weight percent of methyl methacrylate monomer units, preferably at least 70 weight percent and more preferably at least 80 weight percent methyl methacrylate monomer units make up the copolymer. According to an embodiment, the acrylic copolymer comprises, consists or consists essentially of from 80 to 99.8 weight percent (meth)acrylate monomer units, by total weight of the copolymer. The inventive copolymer may comprise, consist of or consist essentially of at least 51 weight % of methyl methacrylate monomer units. The inventive copolymer may comprise, consist of or consist essentially of at least 52, 53, 54, 55, 56, 57, 58, 59, 60, 61, 62, 63, 64, 65, 66, 67, 68, 69, 70, 71, 72, 73, 74, 75, 76, 77, 79, 81, 82, 83, 84, 85, 86, 87, 88, 89, 90, 91, 92, 93, 94, 95, 96, 97, 98, 98.5, 98.6, 98.7, 98.9, 99, 99.1. 99.2, 99.3, 99.4, 99.5, 99.6, 99.7, or 99.8 weight % of methyl methacrylate monomer units.

The copolymer of the invention, in addition to the hydrophobic, high Tg monomer(s), and methyl methacrylate, may comprises, consist of or consist essentially of 0 to 49.5 weight percent of other acrylate and methacrylate monomers or other ethylenically unsaturated monomers, including but not limited to, styrene, alpha methyl styrene, acrylonitrile and derivatives thereof. Crosslinkers at low levels may also be present in the monomer mixture. Suitable acrylate and methacrylate comonomers include, but are not limited to, methyl acrylate, ethyl acrylate and ethyl methacrylate, butyl acrylate and butyl methacrylate, iso-octyl methacrylate and iso-octyl acrylate, lauryl acrylate and lauryl methacrylate, stearyl acrylate and stearyl methacrylate, isobornyl acrylate and isobornyl methacrylate, methoxy ethyl acrylate and methoxy methacrylate, 2-ethoxy ethyl acrylate and 2-ethoxy ethyl methacrylate, and dimethylamino ethyl acrylate and dimethylamino ethyl methacrylate monomers. (Meth) acrylic acids such as methacrylic acid and acrylic acid can be useful for the monomer mixture. In addition to carboxyl functionality, other functionality can be added to the copolymer by including functional comonomers, including epoxy (such as glycidyl methacrylate), hydroxyl, and anhydride functional groups. Functional monomer units (monomer units having a functional group) can be present at up to 70 weight percent of the inventive copolymer, preferably up to 50 weight percent.

According to an embodiment, the copolymer may comprise, consist of or consist essentially of other comonomer, copolymerizable with the hydrophobic comonomers tert-butyl cyclohexyl methacrylate and/or 3,3,5-trimethylcyclohexyl(meth)acrylate, and the (meth)acrylate monomer units. This other comonomer may be present in the polymer at from 0.01 to 49.9 weight %. The comonomer may be present as a polymerized monomer from 0.01 to 25 weight %, preferably from 1 to 10 weight %, most preferably from 2 to 5 weight % based on the weight of the acrylic copolymer. This comonomer may be at least one of methacrylic acid, acrylic acid, itaconic acid, alpha methyl styrene, maleic anhydride, maleimide, isobornyl methacrylate, norbornyl methacrylate, t-butyl methacrylate, cyclohexyl methacrylate, tetra hydrofurfuryl methacrylate, acrylamide and methacrylamide, and mixtures thereof.

In addition to the tert-butyl cyclohexyl methacrylate and 3,3,5-trimethylcyclohexyl(meth)acrylate, other high Tg monomers may optionally be present at levels of 0 to 25 weight percent, and more preferably from 0 to 10 weight percent. The other high Tg monomers may be hydrophilic, hydrophobic or have a neutral character, and include, but are not limited to methacrylic acid, acrylic acid, itaconic acid, alpha methyl styrene, maleic anhydride, maleimide, isobornyl methacrylate, norbornyl methacrylate, t-butyl methacrylate, cyclohexyl methacrylate, acrylamide and methacrylamide.

In one embodiment it was found that the hydrophobic effect of the tert-butyl cyclohexyl methacrylate and/or 3,3,5-trimethylcyclohexyl(meth)acrylate is strong enough to overcome the hydrophilic effect of hydrophilic comonomers used at lower levels, to produce an over-all hydrophobic copolymer.

### Synthesis Process

The copolymers of the invention are obtained through melt polymerization, including but not limited to solution polymerization, emulsion polymerization, and suspension polymerization.

### Additives

The copolymer of the invention can be blended with typical additives used in thermoplastics. These include, but are not limited to fillers, surface modifying additives, processing aids, fibers, lubricant agents, matting agents, heat stabilizers, flame retardants, synergists, pigments or coloring agents.

Other polymer additives may include polycarbonates, polyurethanes, polysulfones, polyamides, polyolefin including copolymers and terpolymers based on these polymers, and including linear, branched, block, and grafted polymer structures. Examples of matting agents include, but are not limited to, cross-linked polymer particles of various geometries. The amount of filler and additives included in the polymer compositions of each layer may vary from about 0.01% to about 70% of the combined weight of polymer, additives and filler. Generally, amounts from about 5% to about 45%, from about 10% to about 40%, are included.

### Impact Modifiers

Impact modifiers may be incorporated into the copolymer of the invention or blends thereof with other polymers. Suitable impact modifiers may comprise, consist of or consist essentially of a core-shell impact modifier. In addition, acrylic impact modifiers (such as MPD91 or MPD85T from Altuglas, and small impact modifiers-SIMs) may be added to the inventive copolymer or compositions including it to provide impact-resistant pMMA resins that are hydrophobic and have high heat performance to improve water resistance and high heat resistance. This impact modified composition may include from 5 to 60 weight %, preferably 5 to 50 weight %, more preferably 20 to 50 weight % of impact modifier, based on total weight of the composition including the impact modifier and the inventive copolymer. The impact modifier may comprise, consist of or consist essentially of at least one of a core-shell impact modifier, an acrylic block copolymer, or a self-assembling, nanostructured polymer, or any combination thereof.

### Blends with Other Polymers

Other polymers may be blended with the inventive copolymers. For example, poly(methyl (meth)acrylate)/ethyl(meth)acrylate copolymer; poly(methyl methacrylate)/methacrylate copolymer, poly(styreneacrylonitrile, SAN), polyvinylidene fluoride, copolymers of vinylidene fluoride and hexafluoropropene; polylactic acid; and combinations thereof maybe blended with the inventive copolymer to provide a polymer composition. Advantageously, the inventive hydrophobic high heat resistant pMMA copolymers/terpolymers can be blended with Nanostrength® block copolymers (from Arkema), styrene acrylonitrile copolymers (SAN), polyvinylidene difluoride (PVDF) homopolymers, poly(vinylidene fluoride-co-hexafluoropropylene) (PVDF-HFP) copolymers, and other compatible polymers for different applications, such as but not limited to co-extruded profiles for building & construction applications, home appliances (such as parts in dishwashers), film laminates for reflective signage. Blends of the copolymers of the invention with other polymers, and especially acrylic polymers is contemplated by the invention. The inventive copolymers or terpolymers of the invention (with the refractive index of 1.47-1.50) are optically and physically compatible with many typical optical acrylic copolymers (with a refractive index of about 1.49) in their mixtures and/or combinations through melt processing/solution blends. The copolymer of the invention would typically be blended with other acrylic resins at 5 to 95 weight percent, preferably 5 to 75 weight percent, and more preferably at 10 to 60 weight percent of the total polymer solids.

Blends with other compatible polymers, in all ratios, are also contemplated. Especially useful compatible polymers for a blend include, but are not limited to, other poly(methyl methacrylate) copolymers such as polymethylmethacrylate-ethyl acrylate (pMMA-EA) and polymethylmethacrylate-methyl acrylate (PMMA-MA), poly(styrene-acrylonitrile, SAN), polyvinylidene fluoride, copolymers of vinylidene fluoride and hexafluoropropene, and polylactic acid.

### Antioxidants

In one embodiment, selected antioxidants may be used to improve the thermal stability of the resins at high temperature such as 255-275° C. and reduce the yellowing at high temperature. The loading of the antioxidants in the final resins formulations are at the levels of ˜50 ppm to 3500 ppm, preferably about 100 ppm to about 2500 ppm based on the total weight of the composition. Non-limiting examples of useful antioxidants include sterically hindered phenols, organophosphites hindered amine light stabilizers (HALS), benzotriazoles, triazines, benzophenones, and cyanoacrylates. For example, the copolymer may include 100 to 2000 ppm weight or 2500 ppm weight of antioxidant comprising at least one of hydroxy phenyl benzotriazoles, sterically hindered phenolics, organo-phosphites, hindered amines, and combinations thereof. These antioxidants are used to improve the thermal stability of the resins at high temperature such as from 255° C. to 275° C. and to reduce the yellowing at high temperature. The loading levels of the antioxidants in the final resin formulations are in the range of from 100 ppm to 2000 ppm weight, or 150 ppm to 1900 ppm, or 200 ppm to 1800 ppm or 150 ppm to 1500 ppm, or 100 ppm to 1000 ppm weight.

### Properties

The novel hydrophobic high heat acrylic materials of the invention are designed to meet the requirement of high light transmission in the visible wavelength region, low haze, high heat resistance, low water/moisture uptake, environmental stability, and sufficient mechanical properties, optionally with excellent UV resistance, making them especially useful in certain high heat, high optical clarity applications. These properties are achieved with the copolymers themselves or compositions including the inventive copolymers that include additives, impact modifiers, antioxidants, and additional polymer as described above.

The polymer composition may have a haze value of less than 2.5%, more preferably less than 1.5% and most preferably less than 0.5%. The polymer composition may have a light transmission value at 560 nm wavelength through a 120 μm film of at least 91%, more preferably at least 91.5% and most preferably at least 92%. The polymer composition may have a refractive index of from 1.47 to 1.50 at 589 nm wavelength. The polymer composition may have a water absorption of less than 2 weight %, preferably less than 1.5 weight % and most preferably less than 1.3 weight % after at least 504 hours in 60° C. water. According to an embodiment, 3.2 mm thick samples of a polymer composition including the inventive copolymer may have no visible stress crazing or cracking defects after 600 hours of exposure to 75 cycles of −40° C. to 80° C./85% RH.

The Tg of the copolymers generally ranges from 115° C. to 150° C., preferably from 116° C. to 140° C., and more preferably from 120° C. to 130° C. The Tg value of the acrylic copolymers is higher than 116° C., preferably higher than 120 ° C., more preferably higher than 125° C., and much more preferably higher than 130° C. The Tg of the copolymers may be from 116° C. to 145° C., preferably from 120° C. to 145° C., more preferably from 125° C. to 145° C., and most preferably from 125° C. to 140° C. The Tg of the copolymer may be from 130° C. to 145° C., or from 130° C. to 140° C. The Tg of the copolymer may be higher than 117° C., 118° C., 119° C., 121° C., 122° C., 123° C., 124° C., 125° C., 126° C., 127° C., 128° C., 129° C., 131° C., 132° C., 133° C., 134° C., 135° C., 136° C., 137° C., 138° C., or 139° C. In a preferred embodiment, the acrylic copolymer has a high Tg of greater than 115° C., more preferably greater than 120° C., greater than 125° C., greater than 130° C., greater than 135° C., and even greater than 140° C. The Tg of the copolymer may be greater than 141° C., 142° C., 143° C., 144° C., 145° C., 146° C., 147° C., 148° C., 149° C. or 150° C.

The weight average molecular weight of the acrylic copolymers is greater than 65,000 g/mole, preferably greater than 75,000 g/mole, more preferably greater than 90,000 g/mole, and even more preferably greater than 100,000 g/mole. The maximum molecular weight is about 250,000 g/mole, and more preferably about 200,000 g/mole. The weight average molecular weight of these hydrophobic pMMA copolymers is higher than 65,000 g/mole, preferably higher than 75,000 g/mole, more preferably higher than 90,000 g/mole, and much more preferably higher than 100,000 g/mole. The weight average molecular weight of these copolymers may be higher than 70,000 g/mole, 75,000 g/mole, 80,000 g/mole, 90,000 g/mole, 100,000 g/mole, 110,000 g/mole, 120,000 g/mole, 130,000 g/mole, 140,000 g/mole, 150,000 g/mole, 160,000 g/mole, 170,000 g/mole, 180,000 g/mole, 190,000 g/mole and/or 200,000 g/mole.

The hydrophobic high Tg copolymers of the invention, including co-, ter-, and tetra-polymers of the invention have a refractive index of 1.47-1.50 at the wavelength of 589 nm. The copolymers of the invention have excellent optical properties, with a total white light transmission (TWLT) of at least 89%, preferably at least 91% and more preferably at least 92%; and an optical haze of less than 5%, preferably less than 3% and most preferably less than 2%.

In addition to the above properties, the copolymer of the invention has excellent environmental stability, and excellent mechanical properties, along with excellent UV resistance.

### Applications

The copolymers of the invention are thermoplastic, and can be easily shaped into sheets, films, light pipe and lenses

The excellent heat stability, high molecular weight, moisture resistance and excellent optical properties, makes the copolymer of the invention especially useful for forming lighting pipes, thin wall parts, optical lenses, extruded films, (co-)extruded sheets/profiles, thermo-formable sheets, cast sheets, composites, and others.

High heat acrylic films of the invention may be used in LED/OLED displays. If energy saving OLED technologies are widely used to replace LED/LCD technologies, the number of new thin polarizers for OLED may be increased while traditional polarizers for LCD will be reduced.

The copolymer and compositions including it may be formed into or used as portions articles of manufacture such as electronic components in automotive front inner thick lenses, automotive thin lenses, smartphones, imaging lenses, photovoltaics, high heat LED diffusing sheets/films, digital printing with hydrophobic surfaces, (window) profiles, protection surface applications, automotive thin wall parts, electronic components, optical thin polarizers for LED/OLED displays, notebooks, and solar electronics (lenses/panels/backsheets). Other such articles in which the inventive copolymer maybe utilized are at least one of electronic components in automotive front inner thick lenses, automotive thin lenses, smartphones, imaging lenses, photovoltaics, high heat LED diffusing sheets/films, digital printing with hydrophobic surfaces, (window) profiles, surface protection applications, medical devices, Li-ion battery binders, automotive thin wall parts, electronic components, optical thin polarizers for LED/OLED displays, notebooks, and solar electronics (lenses/panels/backsheets).

Within this specification embodiments have been described in a way which enables a clear and concise specification to be written, but it is intended and will be appreciated that embodiments may be variously combined or separated without parting from the invention. For example, it will be appreciated that all preferred features described herein are applicable to all aspects of the invention described herein.

Non-limiting aspects of the invention are summarized below.

Aspect 1: An acrylic copolymer comprising, as polymerized monomers:
a) from 0.2 to 20 weight percent, preferably from 0.5 to 10 weight percent of monomer units comprising at least one of tert-butyl cyclohexyl methacrylate, 3,3,5-trimethyl cyclohexyl (meth)acrylate, or a mixture thereof; wherein the monomer a) comprises at least 80 weight %, more preferably at least 85 weight %, and most preferably at least 90 weight % trans isomer;
b) from 80 to 99.8 weight percent (meth)acrylate monomer units;
wherein the acrylic copolymer has:
   i) a Tg of from 116° C. to 145° C., preferably from 120° C. to 145° C., more preferably from 125° C. to 145° C., and most preferably from 125° C. to 140° C.; and
   ii) a weight average molecular weight (Mw) of at least 65,000 g/mole, preferably at least 75,000 g/mole, and more preferably at least 90,000 g/mole and most preferably at least 100,000 g/mol.

2: The acrylic copolymer of Aspect 1, wherein the acrylic copolymer has:
iii) a syndiotacticity (rr) of at least 50%, more preferably at least 55% and most preferably at least 60%.

Aspect 3: The acrylic copolymer of either Aspect 1 or Aspect 2, wherein the acrylic copolymer has the following properties:
iv) a haze value of less than 2.5%, more preferably less than 1.5% and most preferably less than 0.5%;
v) a light transmission value at 560 nm wavelength through a 120 μm film of at least 91%, more preferably at least 91.5% and most preferably at least 92%;
vi) a refractive index of from 1.47 to 1.50 at 589 nm wavelength; and
vii) a water absorption of less than 2 weight %, preferably less than 1.5 weight % and most preferably less than 1.3 weight % after at least 504 hours in 60° C. water.

Aspect 4: The acrylic copolymer of any of Aspects 1-3, wherein the copolymer comprises at least 51 weight % of methyl methacrylate monomer units.

Aspect 5: The acrylic copolymer of any of Aspects 1-4, further comprising, as a polymerized monomer:
c) from 0.01 to 49.9 weight % of at least one additional monomer copolymerizable with monomer a) and b).

Aspect 6: The acrylic copolymer of Aspect 5, wherein the additional monomer c) comprises at least one of methacrylic acid, acrylic acid, itaconic acid, alpha methyl styrene, maleic anhydride, maleimide, isobornyl methacrylate, norbornyl methacrylate, t-butyl methacrylate, cyclohexyl methacrylate, tetrahydrofurfuryl methacrylate, acrylamide and methacrylamide, and mixtures thereof.

Aspect 7: The acrylic copolymer of either Aspect 5 or Aspect 6, wherein the monomer c) is present as a polymerized monomer at from 0.01 to 25 weight %, preferably from 1 to 10 weight %, most preferably from 2 to 5 weight % based on the weight of the acrylic copolymer.

Aspect 8: A composition comprising the acrylic copolymer of any of Aspects 1-7.

Aspect 9: The composition of Aspect 8 comprising from 100 to 2000 ppm weight of antioxidant comprising at least one of hydroxy phenyl benzotriazoles, sterically hindered phenolics, organo-phosphites, hindered amines, and combinations thereof.

Aspect 10: The composition of either Aspect 8 or Aspect 9, comprising from 5 to 60 weight %, preferably 5 to 50 weight %, more preferably 20 to 50 weight % of impact modifier, based on total weight of the composition.

Aspect 11: The composition of Aspect 10, wherein the impact modifier comprises at least one of a core-shell impact modifier, an acrylic block copolymer, or a self-assembling, nanostructured polymer, or any combination thereof.

Aspect 12: The composition of either Aspect 10 or Aspect 11, wherein the impact modifier comprises a core-shell impact modifier.

Aspect 13: The composition of any of Aspects 8-12, comprising at least one of poly(methyl methacrylate)/ethyl acrylate copolymer; poly(methyl methacrylate)/methyl acrylate copolymer; poly(methyl methacrylate)/methacrylate copolymer; poly(styreneacrylonitrile, SAN); polyvinylidene fluoride; copolymers of vinylidene fluoride and hexafluoropropene; polylactic acid; or combinations thereof.

Aspect 14: The composition of any of Aspects 8-13 wherein the composition comprises one or more additives at an effective amount, comprising at least one of impact modifiers, fillers, surface modifying additives, processing aids, fibers, lubricant agents, matting agents, heat stabilizers, flame retardants, synergists, pigments or coloring agents.

Aspect 15: The composition of any of Aspects 8-14, wherein the composition has the following properties:
iv) a haze value of less than 2.5%, more preferably less than 1.5% and most preferably less than 0.5%;
v) a light transmission value at 560 nm wavelength through a 120 μm film of at least 91%, more preferably at least 91.5% and most preferably at least 92%;
vi) a refractive index of from 1.47 to 1.50 at 589 nm wavelength; and
vii) a water absorption of less than 2 weight %, preferably less than 1.5 weight % and most preferably less than 1.3 weight % after at least 504 hours in 60° C. water.

Aspect 16: The composition of any of Aspects 8-15, wherein 3.2 mm thick samples of the composition have no visible stress crazing or cracking defects after 600 hours of exposure to 75 cycles of −40° C. to 80° C./85% RH.

Aspect 17: An article comprising the acrylic copolymer of any of Aspects 1-7, wherein the article is at least one of electronic components in automotive front inner thick lenses, automotive interior thin lenses, smartphones, imaging lenses, photovoltaics, high heat LED diffusing sheets/films, digital printing with hydrophobic surfaces, (window) profiles, surface protection, applications, automotive thin wall parts, medical devices, Li-ion battery binders, electronic components, optical thin polarizers for LED/OLED displays, notebooks, and solar electronics (lenses/panels/backsheets).

Aspect 18: An article comprising the composition of any of Aspects 8-16, wherein the article is at least one of electronic components in automotive front inner thick lenses, automotive thin lenses, smartphones, imaging lenses, photovoltaics, high heat LED diffusing sheets/films, digital printing with hydrophobic surfaces, (window) profiles, capstock applications, automotive thin wall parts, electronic components, optical thin polarizers for LED/OLED displays, notebooks, and solar electronics (lenses/panels/backsheets).

### EXAMPLES

### Testing Methods

Injection molded samples: In the testing below involving injection molded samples or plaques, the plaque sample size was molded at 45 mm (width)×67 mm (length)×3.2 mm (thickness).

Melt flow rate (MFR) measurement: Instron Ceast MF30 equipment was used for polymers in melt flow rate measurements. The die temperature was controlled at 230° C. while the loading cell weight was at 3.8 kg. The dried pellets were used near 20° C. below the T_{g} over 8 hours.

Gel permeation chromatography (GPC): Waters Alliance 2695 and Waters Differential Refractometer 2410 were used to make polymer molecular weight measurements. Columns were based on two PL Gel mixed C columns and a guard column (7.8 mm I.D.×30 cm, 5 μm). THF (HPLC grade) was selected as a solvent. Temperature was controlled at 35° C. Ten poly(methyl methacrylate) standards were used in the calibration, ranging in Mₚ (peak molecular weight) from 550 to 1,677,000 g/mole.

Differential scanning calorimetry (DSC): The glass transition temperatures of acrylic polymers were measured at a heating rate of 10° C./minutes in N₂ using TA instruments Q2000 DSC, during the second heating. The first heating was used to heat the sample to 170° C. at a heating rate of 10° C./minute, then, the sample was cooled down to 0° C. at a cooling rate of 10° C./minute. The sample weight was controlled at 5-10 mg.

Thermogravimetry (TGA): The thermal decomposition temperatures of acrylic polymers were measured at a heating rate of 10° C./minute in N₂ using TA instruments Q5000 TGA. The sample weight was controlled at 5-10 mg. The samples were pre-dried under a vacuum oven at 100° C. overnight.

Total light transmission: The total light transmission was measured from film and/or plaque samples in a transmission mode using Perkin Elmer Lambda 950 with a 150 mm integrating sphere. The selected UV/Vis wavelength range was from 200 nm to 800 nm in UV/Vis region.

Haze: Optical haze of clear film and/or plaque samples was measured using BYK HazeGard Plus under ASTM method D1003.

Tensile strength and elongation: The tensile strength, modulus and elongation of the tensile bars was evaluated using Instron Model 4202 at the crosshead speed of 5 mm/minute using ASTM D638 method after being preconditioned at 23° C./48 hours. The tensile was at 6″ in length while the width was at 0.50″. The sample thickness was at 0.125″.

Refractive index: Refractive index of the polymer film was measured at three different wavelengths of 402 nm, 518 nm, and 636.5 nm using an optical prism coupler Metricon 2010 from Metricon Inc. while the refractive index was calculated at a selected wavelength of 589 nm.

NMR: Samples were prepared by dissolving ˜200 mg of pellets in ˜4 ml CDCl₃ in separate 10 mm NMR tubes for ¹³C NMR. The ¹H spectra were acquired on the Bruker AV III HD 500 (11.07 T) spectrometer with a 5 mm ¹H/¹⁹F/¹³C TXO probe at 25° C. before and after derivatization of MAA. The ¹³C spectra were acquired on the Bruker AV 400 (9.4 T) with a 10 mm BBO probe at 50° C.

Vicat softening temperatures: The samples were tested in Instron HV6M under 10N and 50N external forces using ASTM method D1525. The sample heating rate was controlled at the speed of 50° C./hour. The injection molded samples were annealed at ˜20 C below the Tg value for 16 hours and were kept in a desiccator oven before testing.

Water absorption: The injection molded samples were immersed in a D. I. water bath (23° C.) using ASTM method D570. The water absorption value was measured based on the weight gain while the sample surfaces were cleaned up with dry tissues.

Notched Izod impact: Notched Izod impact strength or resistance was measured using ASTM D256 method with a 1.0 J impact hammer at 23° C./50% relative humidity. The notched Izod bars were injection-molded at the size of 10.2 mm (width)×100 mm (long)×3.2 mm (thick).

Syndiotacticity: Syndiotacticity (rr) from the solution polymerized pMMA copolymer was determined to be ˜60% from the chemical shift of 44.5 ppm using ¹³C NMR. Isotaticity (mm) and atacticity (rm) were measured as about 4% and about 36% from 45.5 ppm and 45.0 ppm using ¹³C NMR. The tacticity calculation from ¹³C NMR was completed using the signals of the C_{α} carbons.

### Example 1 (pMMA Copolymer Containing 1.9% Tert-Butyl Cyclohexyl Methacrylate with Tg of 127° C.)

This example demonstrates the preparation of a high molecular weight copolymer of methyl methacrylate and tert-butyl cyclohexyl methacrylate (from Sartomer, with the melt temperature of 43° C.). 88.07 parts of methyl methacrylate, and 1.93 parts of tert-butyl cyclohexyl methacrylate (solid, dissolved in 10 parts of methyl methacrylate) were charged into a reaction vessel containing 300 parts of toluene near 23° C. with a mechanical stirring speed of 380 rpm. In addition, AIBN (from Aldrich) was used as an initiator at a level of 0.247 parts. The polymerization reaction occurred at 66° C. for 7 hours. When the conversion reached >60%, the residual monomers were removed through a precipitation in methanol (MeOH, at least ×10 times). After the samples being dried at 160° C. overnight, the resulting polymers were re-dissolved in acetone and precipitated in MeOH (at least ×10 times) again. The re-precipitated white powder samples were dried at 120° C. overnight and at 165° C. in a vacuum oven for 8 hours. The melt flow rate of the polymer was measured to be 1.5 g/10 minutes at 230° C. under 3.8 kg. The refractive index of the resulting polymer was measured at 1.491 at 589 nm.

The resulting polymer was confirmed using ¹H NMR to possess the composition of pMMA/tert-butyl cyclohexyl methacrylate (98.1/1.9 w/w), with a 94%/6% trans/cis isomer ratio in the t-BCHMA containing copolymer. The syndiotacticity of the copolymer was determined to be 60% from the chemical shift of 44.5 ppm using ¹³C NMR while the isotaticity and atacticity were measured as 4% and 36% from 45.5 ppm and 45.0 ppm. The glass transition temperature (Tg) of the resulting polymer was measured to be 127° C. in N₂ using DSC at the heating rate of 10° C./minute. The weight average molecular weight Mw of the resin was measured as being 118,000 g/mole using GPC along with an Mw/Mn (polydispersity) value of 2.1. The light transmission from a 120 um film was measured to be 92.2% at 560 nm using Lambda 950 while the haze was measured to be 0.3% using a hazemeter (Haze Gard Plus from BYK).

### Example 2 (pMMA Copolymer Containing 2.7% Tert-Butyl Cyclohexyl Methacrylate with Tg of 127° C.)

This example demonstrates the preparation of a high molecular weight copolymer of methyl methacrylate and tert-butyl cyclohexyl methacrylate (from Sartomer, with the melt temperature of 42° C.). 87.28 parts of methyl methacrylate, and 2.72 parts of tert-butyl cyclohexyl methacrylate (solid, dissolved in 10 parts of methyl methacrylate) were charged into a reaction vessel containing 300 parts of toluene near 23° C. with a mechanical stirring speed of 380 rpm. In addition, AIBN (from Aldrich) was used as an initiator at a level of 0.211 parts. The polymerization reaction occurred at 66° C. for 7 hours. When the conversion reached >60%, the residual monomers were removed through a precipitation in methanol (MeOH, at least ×10 times). After the samples being dried at 160° C. overnight, the resulting polymers were re-dissolved in acetone and precipitated in MeOH (at least ×10 times)again. The re-precipitated white powder samples were dried at 120° C. overnight and at 165° C. in a vacuum oven for 8 hours. The melt flow rate of the polymer was measured to be 1.6 g/10 minutes at 230° C. under 3.8 kg. The refractive index of the resulting polymer was measured at 1.491 at 589 nm.

The resulting polymer was confirmed using ¹H NMR to possess the composition of pMMA/tert-butyl cyclohexyl methacrylate (97.0/3.0 w/w), with a 96%/4% trans/cis isomer ratio in the t-BCHMA containing copolymer. The syndiotacticity of the copolymer was determined to be 60% from the chemical shift of 44.5 ppm using ¹³C NMR while the isotaticity and atacticity were measured as 4% and 36% from 45.5 ppm and 45.0 ppm. The glass transition temperature (Tg) of the resulting polymer was measured to be 127° C. in N₂ using DSC at the heating rate of 10° C./minute. The weight average molecular weight Mw of the resin was measured as being 117,000 g/mole using GPC along with an Mw/Mn (polydispersity) value of 1.6. The light transmission from a 120 um film was measured to be 92.2% at 560 nm using Lambda 950 while the haze was measured to be 0.4% using a hazemeter (Haze Gard Plus from BYK).

### Example 3 (pMMA Copolymer Containing 7.2% Tert-Butyl Cyclohexyl Methacrylate with Tg=˜129° C.)

This example demonstrates the preparation of a high molecular weight copolymer of methyl methacrylate and tert-butyl cyclohexyl methacrylate (from Sartomer, with the melt temperature of ˜42° C.). 82.55 parts of methyl methacrylate, and 7.19 parts of tert-butyl cyclohexyl methacrylate (solid, dissolved in 10 parts methyl methacrylate) were charged into a reaction vessel containing 300 parts of toluene near 23° C. with a mechanical stirring speed of 380 rpm. In addition, AIBN (from Aldrich) was used as an initiator at a level of 0.263 parts. The polymerization reaction occurred at 67° C. for 7 hours. When the conversion reached >60%, the residual monomers were removed through a precipitation in methanol (MeOH, at least ×10 times). After the samples being dried at 160° C. overnight, the resulting polymers were re-dissolved in acetone and precipitated in MeOH (at least ×10 times) again. The re-precipitated white powder samples were dried at 120° C. overnight and at 165° C. in a vacuum oven for 8 hours. The melt flow rate of the polymer was measured to be 2.9 g/10 minutes at 230° C. under 3.8 kg. The refractive index of the resulting polymer was measured at 1.489 at 589 nm.

The resulting polymer was confirmed using ¹H NMR to possess the composition of pMMA/tert-butyl cyclohexyl methacrylate (92.4/7.6 w/w), with a 86%/14% trans/cis isomer ratio in the t-BCHMA containing copolymer. The syndiotacticity of the copolymer was determined to be 61% from the chemical shift of 44.5 ppm using ¹³C NMR while the isotaticity and atacticity were measured as 3% and 36% from 45.5 ppm and 45.0 ppm. The glass transition temperature (Tg) of the resulting polymer was measured to be 129° C. in N₂ using DSC at the heating rate of 10° C./minute. The weight average molecular weight Mw of the resin was measured as being 96,000 g/mole using GPC along with an Mw/Mn (polydispersity) value of 1.6. The light transmission from a 120 um film was measured to be 92.2% at 560 nm using Lambda 950 while the haze was measured to be 0.3% using a hazemeter (Haze Gard Plus from BYK).

### Example 4 (pMMA Copolymer Containing 9.8% Tert-Butyl Cyclohexyl Methacrylate with Tg=˜132° C.)

This example demonstrates the preparation of a high molecular weight copolymer of methyl methacrylate and tert-butyl cyclohexyl methacrylate (from Sartomer, with the melt temperature of 43° C.). 79.85 parts of methyl methacrylate, and 9.89 parts of tert-butyl cyclohexyl methacrylate (solid, dissolved in 10 parts methyl methacrylate) were charged into a reaction vessel containing 300 parts of toluene near 23° C. with a mechanical stirring speed of 360 rpm. In addition, AIBN (from Aldrich) was used as an initiator at a level of 0.265 parts. The polymerization reaction occurred at 68° C. for 7 hours. When the conversion reached >60%, the residual monomers were removed through a precipitation in methanol (MeOH, at least ×10 times). After the samples being dried at 160° C. overnight, the resulting polymers were re-dissolved in acetone and precipitated in MeOH (at least ×10 times) again. The re-precipitated white powder samples were dried at 120° C. overnight and at 165° C. in a vacuum oven for 8 hours. The melt flow rate of the polymer was measured to be 7.5 g/10minutes at 230° C. under 3.8 kg. The refractive index of the resulting polymer was measured at 1.488 at 589 nm.

The resulting polymer was confirmed using ¹H NMR to possess the composition of pMMA/t-BCHMA (90.2/9.8 w/w), with a 96%/4% trans/cis isomer ratio in the t-BCHMA containing copolymer. The syndiotacticity of the copolymer was determined to be 61% from the chemical shift of 44.5 ppm using ¹³C NMR while the isotaticity and atacticity were measured as 3% and 36% from 45.5 ppm and 45.0 ppm. The glass transition temperature (Tg) of the resulting polymer was measured to be 132° C. in N₂ using DSC at the heating rate of 10° C./minute. The weight average molecular weight Mw of the resin was measured as being 80,000 g/mole using GPC along with an Mw/Mn (polydispersity) value of 1.6. The light transmission from a 120 um film was measured to be 92.3% at 560 nm using Lambda 950 while the haze was measured to be 0.3% using a hazemeter (Haze Gard Plus from BYK).

### Example 5 (pMMA Terpolymer Containing 2.0% Tert-Butyl Cyclohexyl Methacrylate and 4.3% MAA with Tg=˜136° C.)

This example demonstrates the preparation of a high molecular weight copolymer of methyl methacrylate and tert-butyl cyclohexyl methacrylate (from Sartomer, with the melt temperature of 43° C.). 83.70 parts of methyl methacrylate, 4.34 parts of methacrylic acid, and 1.96 parts of tert-butyl cyclohexyl methacrylate (solid, dissolved in 10 parts methyl methacrylate) were charged into a reaction vessel containing 300 parts of toluene near 23° C. with a mechanical stirring speed of 390 rpm. In addition, AIBN (from Aldrich) was used as an initiator at a level of 0.285 parts. The polymerization reaction occurred at 68° C. for 7 hours. When the conversion reached >60%, the residual monomers were removed through a precipitation in methanol (MeOH, at least ×10 times). After the samples being dried at 160° C. overnight, the resulting polymers were re-dissolved in acetone and precipitated in MeOH (at least ×10 times) again. The re-precipitated white powder samples were dried at 120° C. overnight and at 165° C. in a vacuum oven for 8 hours. The melt flow rate of the polymer was measured to be 0.7 g/10 minutes at 230° C. under 3.8 kg. The refractive index of the resulting polymer was measured at 1.492 at 589 nm.

The resulting polymer was confirmed using ¹H NMR and ¹³C NMR to possess the composition of pMMA/t-BCHMA/MAA/anhydride (93.5/2.0/4.1/0.4 w/w/w), with a 98%/2% trans/cis isomer ratio in the t-BCHMA containing copolymer. The syndiotacticity of the copolymer was determined to be 61% from the chemical shift of 44.5 ppm using ¹³C NMR while the isotaticity and atacticity were measured as 3% and 36% from 45.5 ppm and 45.0 ppm. The glass transition temperature (Tg) of the resulting polymer was measured to be 136° C. in N₂ using DSC at the heating rate of 10° C./minute. The weight average molecular weight Mw of the resin was measured as being 130,000 g/mole using GPC along with an Mw/Mn (polydispersity) value of 1.7. The light transmission from a 120 um film was measured to be 92.3% at 560 nm using Lambda 950 while the haze was measured to be 0.3% using a hazemeter (Haze Gard Plus from BYK).

### Example 6 (pMMA Copolymer Containing 1.2% 3,3,5-Trimethyl Cyclohexyl Methacrylate with Tg of 126° C.)

This example demonstrates the preparation of a high molecular weight copolymer of methyl methacrylate, and 3,3,5-trimethyl cyclohexyl methacrylate (TMCHMA, from Sartomer). 98.83 parts of methyl methacrylate, and 1.17 parts of 3,3,5-trimethyl cyclohexyl methacrylate were charged into a reaction vessel containing 300 parts of toluene near 23° C. with a mechanical stirring speed of 380 rpm. In addition, AIBN (from Aldrich) was used as an initiator at a level of 0.320 parts. The polymerization reaction occurred at 70° C. for 7 hours. When the conversion reached >60%, the residual monomers were removed through a precipitation in methanol (MeOH, at least ×10 times). After the samples being dried at 160° C. overnight, the resulting polymers were re-dissolved in acetone and precipitated in MeOH (at least ×10 times) again. The re-precipitated white powder samples were dried at 120° C. overnight and at 170° C. in a vacuum oven for 8 hours. The melt flow rate of the polymer was measured to be 6.3 g/10 minutes at 230° C. under 3.8 kg. The refractive index of the resulting polymer was measured at 1.491 at 589 nm.

The resulting polymer was confirmed using ¹H NMR to possess the composition of pMMA/3,3,5-trimethyl cyclohexyl methacrylate (98.7/1.3w/w), with a 87%/13% trans/cis isomer ratio in TMCHMA containing copolymer. The syndiotacticity of the copolymer was determined to be 60% from the chemical shift of 44.5 ppm using ¹³C NMR while the isotaticity and atacticity were measured as 4% and 36% from 45.5 ppm and 45.0 ppm. The glass transition temperature (Tg) of the resulting polymer was measured to be 126° C. in N₂ using DSC at the heating rate of 10° C./minute. The weight average molecular weight Mw of the resin was measured as being 80,000 g/mole using GPC along with an Mw/Mn (polydispersity) value of 1.7. The light transmission from a 120 um film was measured to be 92.2% at 560 nm using Lambda 950 while the haze was measured to be 0.3% using a hazemeter (Haze Gard Plus from BYK).

### Example 7 (pMMA Copolymer Containing 2% 3,3,5-Trimethyl Cyclohexyl Methacrylate with Tg of 126° C.)

This example demonstrates the preparation of a high molecular weight copolymer of methyl methacrylate, and 3,3,5-trimethyl cyclohexyl methacrylate (TMCHMA, from Sartomer). 97.99 parts of methyl methacrylate, and 2.01 parts of 3,3,5-trimethyl cyclohexyl methacrylate were charged into a reaction vessel containing 300 parts of toluene near 23° C. with a mechanical stirring speed of 380 rpm. In addition, AIBN (from Aldrich) was used as an initiator at a level of 0.207 parts. The polymerization reaction occurred at 70° C. for 7 hours. When the conversion reached >60%, the residual monomers were removed through a precipitation in methanol (MeOH, at least ×10 times). After the samples being dried at 160° C. overnight, the resulting polymers were re-dissolved in acetone and precipitated in MeOH (at least ×10 times) again. The re-precipitated white powder samples were dried at 120° C. overnight and at 170° C. in a vacuum oven for 8 hours. The melt flow rate of the polymer was measured to be 1.2 g/10 minutes at 230° C. under 3.8 kg. The refractive index of the resulting polymer was measured at 1.491 at 589 nm.

The resulting polymer was confirmed using ¹H NMR to possess the composition of pMMA/3,3,5-trimethyl cyclohexyl methacrylate (98.1/1.9 w/w), with a 87%/13% trans/cis isomer ratio in TMCHMA containing copolymer. The syndiotacticity of the copolymer was determined to be 60% from the chemical shift of 44.5 ppm using ¹³C NMR while the isotaticity and atacticity were measured as 4% and 36% from 45.5 ppm and 45.0 ppm. The glass transition temperature (Tg) of the resulting polymer was measured to be 126° C. in N₂ using DSC at the heating rate of 10° C./minute. The weight average molecular weight Mw of the resin was measured as being 124,000 g/mole using GPC along with an Mw/Mn (polydispersity) value of 1.7. The light transmission from a 120 um film was measured to be 92.2% at 560 nm using Lambda 950 while the haze was measured to be 0.5% using a hazemeter (Haze Gard Plus from BYK).

### Example 8 (pMMA Copolymer Containing 2.6% Tert-Butyl Cyclohexyl Methacrylate +1% 3,3,5-Trimethyl Cyclohexyl Methacrylate with Tg of 128° C.)

This example demonstrates the preparation of a high molecular weight terpolymer of methyl methacrylate, tert-butyl cyclohexyl methacrylate (from Sartomer, with the melt temperature of 43° C.) and 3,3,5-trimethyl cyclohexyl methacrylate (from Sartomer). 86.29 parts of methyl methacrylate, 2.55 parts of tert-butyl cyclohexyl methacrylate (solid, dissolved in 10 parts of methyl methacrylate), and 0.97 parts of 3,3,5-trimethyl cyclohexyl methacrylate were charged into a reaction vessel containing 300 parts of toluene near 23° C. with a mechanical stirring speed of 320 rpm. In addition, AIBN (from Aldrich) was used as an initiator at a level of 0.192 parts. The polymerization reaction occurred at 69° C. for 7 hours. When the conversion reached >60%, the residual monomers were removed through a precipitation in methanol (MeOH, at least ×10 times). After the samples being dried at 160° C. overnight, the resulting polymers were re-dissolved in acetone and precipitated in MeOH (at least ×10 times) again. The re-precipitated white powder samples were dried at 120° C. overnight and at 175° C. in a vacuum oven for 8 hours. The melt flow rate of the polymer was measured to be 1.6 g/10 minutes at 230° C. under 3.8 kg. The refractive index of the resulting polymer was measured at 1.491 at 589 nm.

The resulting polymer was confirmed using ¹H NMR to possess the composition of pMMA/tert-butyl cyclohexyl methacrylate/3,3,5-trimethyl cyclohexyl methacrylate (96.4/2.6/1.0 w/w) with a 90%/10% trans/cis isomer ratio in t-BCHMA and a 87%/13% trans/cis isomer ratio in TMCHMA for the related terpolymer. The syndiotacticity of the copolymer was determined to be 60% from the chemical shift of 44.5 ppm using ¹³C NMR while the isotaticity and atacticity were measured at 4% and 36% from 45.5 ppm and 45.0 ppm. The glass transition temperature (Tg) of the resulting polymer was measured to be 128° C. in N₂ using DSC at the heating rate of 10° C./minute. The weight average molecular weight Mw of the resin was measured as being 116,000 g/mole using GPC along with an Mw/Mn (polydispersity) value of 1.8. The light transmission from a 120 um film was measured to be 92.2% at 560 nm using Lambda 950 while the haze was measured to be 0.3% using a hazemeter (Haze Gard Plus from BYK).

### Example 9 (pMMA Copolymer Containing 6.1% Tert-Butyl Cyclohexyl Methacrylate +1% 3,3,5-Trimethyl Cyclohexyl Methacrylate with Tg of 128° C.)

This example demonstrates the preparation of a high molecular weight terpolymer of methyl methacrylate, tert-butyl cyclohexyl methacrylate (from Sartomer, with the melt temperature of 43° C.) and 3,3,5-trimethyl cyclohexyl methacrylate (from Sartomer). 86.29 parts of methyl methacrylate, 2.55 parts of tert-butyl cyclohexyl methacrylate (solid, dissolved in 10 parts of methyl methacrylate), and 0.97 parts of 3,3,5-trimethyl cyclohexyl methacrylate were charged into a reaction vessel containing 300 parts of toluene near 23° C. with a mechanical stirring speed of 320 rpm. In addition, AIBN (from Aldrich) was used as an initiator at a level of 0.192 parts. The polymerization reaction occurred at 69° C. for 7 hours. When the conversion reached >60%, the residual monomers were removed through a precipitation in methanol (MeOH, at least ×10 times). After the samples were dried at 160° C. overnight, the resulting polymers were re-dissolved in acetone and precipitated in MeOH (at least 10 times) again. The re-precipitated white powder samples were dried at 120° C. overnight and at 175° C. in a vacuum oven for 8 hours. The melt flow rate of the polymer was measured to be 1.8 g/10 minutes at 230° C. under 3.8 kg. The refractive index of the resulting polymer was measured at 1.489 at 589 nm.

The resulting polymer was confirmed using ¹H NMR to possess the composition of pMMA/tert-butyl cyclohexyl methacrylate/3,3,5-trimethyl cyclohexyl methacrylate (92.9/6.1/1.0 w/w) with a 93%/7% trans/cis isomer ratio in t-BCHMA and a 87%/13% trans/cis isomer ratio in TMCHMA for the related terpolymer. The syndiotacticity of the copolymer was determined to be 60% from the chemical shift of 44.5 ppm using ¹³C NMR while the isotaticity and atacticity were measured as 4% and 36% from 45.5 ppm and 45.0 ppm. The glass transition temperature (Tg) of the resulting polymer was measured to be 128° C. in N₂ using DSC at the heating rate of 10° C./minute. The weight average molecular weight Mw of the resin was measured as being 107,000 g/mole using GPC along with an Mw/Mn (polydispersity) value of 1.8. The light transmission from a 120 um film was measured to be 92.2% at 560 nm using Lambda 950 while the haze was measured to be 0.3% using a hazemeter (Haze Gard Plus from BYK).

### Example 10 (pMMA Copolymer Containing 1.6% 3,3,5-Trimethyl Cyclohexyl Methacrylate+3.1% MMA with Tg of 132° C.)

This example demonstrates the preparation of a high molecular weight terpolymer of methyl methacrylate, 3,3,5-trimethyl cyclohexyl methacrylate (CD421 from Sartomer) and methacrylic acid (MMA). 95.42 parts of methyl methacrylate, 3.05 parts of methacrylic acid, and 1.63 parts of 3,3,5-trimethyl cyclohexyl methacrylate were charged into a reaction vessel containing 300 parts of toluene near 23° C. with a mechanical stirring speed of 360 rpm. In addition, AIBN (from Aldrich) was used as an initiator at a level of 0.269 parts. The polymerization reaction occurred at 68° C. for 7 hours. When the conversion reached >60%, the residual monomers were removed through a precipitation in methanol (MeOH, at least ×10 times). After the samples were dried at 160° C. overnight, the resulting polymers were re-dissolved in acetone and precipitated in MeOH (at least ×10 times) again. The re-precipitated white powder samples were dried at 120° C. overnight and at 175° C. in a vacuum oven for 8 hours. The melt flow rate of the polymer was measured to be 1.1 g/10 minutes at 230° C. under 3.8 kg. The refractive index of the resulting polymer was measured as 1.492 at 589 nm.

The resulting polymer was confirmed using ¹H NMR and ¹³C NMR to possess the composition of pMMA/3,3,5-trimethyl cyclohexyl methacrylate/MAA/anhydride (95.3/1.6/2.6/0.5 w/w), with a 87%/13% trans/cis isomer ratio in TMCHMA containing copolymer. The syndiotacticity of the copolymer was determined to be 60% from the chemical shift of 44.5 ppm using ¹³C NMR while the isotaticity and atacticity were measured as 4% and 36% from 45.5 ppm and 45.0 ppm. The glass transition temperature (Tg) of the resulting polymer was measured to be 132° C. in N₂ using DSC at the heating rate of 10° C./minute. The weight average molecular weight Mw of the resin was measured as being 102,000 g/mole using GPC along with an Mw/Mn (polydispersity) value of 1.7. The light transmission from a 120 um film was measured to be 92.2% at 560 nm using Lambda 950 while the haze was measured to be 0.3% using a hazemeter (Haze Gard Plus from BYK).

### Example 11 (1% Tert-Butyl Cyclohexyl Methacrylate with Tg=119° C.)

This example demonstrates the preparation of a high molecular weight copolymer of methyl methacrylate and tert-butyl cyclohexyl methacrylate (from Sartomer, with the melting temperature of 43° C.). 9816 parts of methyl methacrylate and 150 parts of tert-butyl cyclohexyl methacrylate were charged in to a reaction vessel near 0° C. under N₂ with a mechanical stirring speed of 100 rpm. In addition, Luperox® 531 (from Arkema) was used as an initiator at a level of 1.6 parts while 32 parts of n-dodecyl mercaptan (n-DDM from Aldrich) was used as a chain transfer agent, along with 1.0 parts of di-tert-dodecyl disulfide (DtDDS from Arkema). The polymerization reaction occurred at 160° C. for 5 hours. When the conversion reached 50%, the residual monomers were removed through a venting system. The resulting polymer was passed through a single-screw extruder at a die temperature of 235° C. while the barrel temperatures were at 230-245° C. The melt stream went through a water bath before the pelletization. Then the polymer was pelletized into 3-4 mm long resin pellets and dried at 100° C. in a desiccator oven for 8 hours. The melt flow rate of the polymer was measured to be 2.1 g/10 minutes at 230° C. under 3.8 kg. The refractive index of the resulting polymer was measured at 1.491 at 589 nm.

The resulting polymer was confirmed using ¹H NMR to possess the composition of pMMA/tert-butyl cyclohexyl methacrylate (98.5/1.5 w/w) with the trans/cis isomer ratio of 86%/14% in t-BCHMA. The syndiotacticity of the copolymer was determined to be 51% from the chemical shift of 44.5 ppm using ¹³C NMR while the isotaticity and atacticity were measured as 8% and 41% from 45.5 ppm and 45.0 ppm. The glass transition temperature of the resin was measured to be 119° C. in N₂ using DSC at the heating rate of 10° C./minute while the Vicat temperature was detected at 118° C. under 10N. The weight average molecular weight Mw of the resin was measured as being 105,000 g/mole using GPC along with an Mw/Mn (polydispersity) value of 2.0. The light transmission from a 3.2 mm plaque was measured to be 92.3% at 560 nm using Lambda 950 while the haze was measured to be 0.5% using a hazemeter (Haze Gard Plus from BYK). The tensile modulus of the test sample was at 3.1 GPa while the tensile strength was at 72 MPa, along with a tensile elongation of 10%.

### Example 12 (Example 11 Copolymer with 35% Impact Modifier with Tg=˜118° C.).

This example demonstrates the preparation of a high molecular weight copolymer of methyl methacrylate and tert-butyl cyclohexyl methacrylate (containing 86% trans/14% cis isomer) with melt flow rate of 2.2 g/10 minutes at 230° C., along with a commercial core-shell acrylic impact modifier (35% MPD85T from Altuglas).

High Tg hydrophobic acrylic resins (Tg=119° C.) were compounded with core-shell acrylic impact modifiers having an average particle size of ˜250 nm (MPD85T from Altuglas) to form impact acrylic resins using a twin-screw extruder (from Leistritz) with the compounding speed of 50 lbs/hour at a die temperature of 230° C. under a full vacuum. UV stabilizer was also added into the formulation through pre-blending in the compounding. The compounded acrylic pellets were cut through a water cooling bath at ambient temperature and dried at 100° C.

| Example 12 composition | Suppliers | Amount (parts) |
|---|---|---|
| Acrylic copolymer (Example 11) | Arkema | 6442.5 |
| Core Shell Impact Modifier | Arkema | 3500 |
| Tinuvin ® 234 | BASF | 50 |
| Irganox ® 1010 | BASF | 5 |
| Irgafos ® 126 | BASF | 2.5 |

The melt flow rate of the resulting polymer was measured to be 0.72 g/10 minutes at 230° C. under 3.8 kg. The refractive index of the resulting polymer was measured at 1.491 at 589 nm. The glass transition temperature of the resin was measured to be 118° C. in N₂ using DSC at the heating rate of 10° C./minute while the Vicat softening temperature was detected to be 117° C. under 10N. The weight average molecular weight Mw of the resin was measured as being 104,000 g/mole using GPC along with an Mw/Mn (polydispersity) value of 1.9. The light transmission from a 180 um film was measured to be 91.6% at 560 nm using Lambda 950 while the haze was measured to be 2.0% using a hazemeter (Haze Gard Plus from BYK). The tensile modulus of the test sample was 2.0 GPa while the tensile strength was 47 MPa, along with a tensile elongation of 75%. Water absorption was measured at 1.45% by weight gain percentage at the water immersion time of 504 hours. Notched Izod impact strength was measured as 4.8 kJ/m².

TABLE 1
Compositions and physical performance

| | Example 1B | Example 2B | Example 3B | Example 4B | Example 5B |
|---|---|---|---|---|---|
| Compositions | PMMA/ | PMMA/ | PMMA/ | PMMA/ | PMMA/ |
| | t-BCHMA | t-BCHMA | t-BCHMA | t-BCHMA | t-BCHMA/ |
| | 98.1/1.9 | 97.3/2.7 | 92.4/7.6 | 90.2/9.8 | MAA/Anhydride |
| | | | | | 93.5/2/4.1/0.4 |
| Trans/cis of | 94/6 | 97/3 | 86/14 | 96/4 | 98/2 |
| t-BCHMA | (at 4.5 ppm/ | | | | |
| (or TMCHMA) | 4.9 ppm in | | | | |
| in copolymers | 1H NMR) | | | | |
| Syndiotacticity | 60 | 60 | 61 | 61 | 60 |
| (rr) | | | | | |
| isotaticity (mm) | 4 | 4 | 3 | 3 | 4 |
| Atacticity (rm) | 36 | 36 | 36 | 36 | 36 |
| MFR | 1.5 | 1.6 | 2.9 | 7.5 | 0.7 |
| (g/10 min.) | | | | | |
| Light | 92.2 | 92.2 | 92.2 | 92.3 | 92.3 |
| transmission % | | | | | |
| (120 μm, 560 nm) | | | | | |
| Refractive | 1.491 | 1.491 | 1.489 | 1.488 | 1.492 |
| index (589 nm) | | | | | |
| Tg (C.) | 127 | 127 | 129 | 132 | 136 |
| Haze % | 0.3 | 0.4 | 0.3 | 0.3 | 0.3 |
| Vicat (C.) | | | | | |
| @10N | | | | | |
| Mw | 118,000 | 117,000 | 96,000 | 80,000 | 130,000 |
| Mw/Mn | 2.1 | 1.7 | 1.6 | 1.6 | 1.7 |

TABLE 2
Compositions and physical performance (continued)

| | Example 6B | Example 7B | Example 8B | Example 9B | Example 10B |
|---|---|---|---|---|---|
| Compositions | PMMA/ | PMMA/ | PMMA/ | PMMA/t- | PMMA/ |
| | TMCHMA | TMCHMA | t-BCHMA/ | BCHMA/ | TMCHMA/MAA/ |
| | 98.7/1.3 | 98.1/1.9 | TMCHMA | TMCHMA | anhydride |
| | | | 96.5/2.5/1 | 93.3/5.7/1 | 95.3/1.6/2.6/0.5 |
| Trans/cis of | 88/12 | 87/13 | 90/10; | 93/7; | 88/12 |
| t-BCHMA (or | (at 4.8 ppm | | 87/13 | 87/13 | |
| TMCHMA) in | 5.1 ppm in | | | | |
| copolymers | ¹H NMR) | | | | |
| Syndiotacticity (rr) | 60 | 60 | 60 | 59 | 60 |
| isotaticity (mm) | 4 | 4 | 4 | 4 | 4 |
| Atacticity (rm) | 36 | 36 | 36 | 37 | 36 |
| MFR (g/10 min.) | 6.3 | 1.2 | 1.6 | 1.8 | 1.1 |
| Light | 92.2 | 92.2 | 92.2 | 92.2 | 92.2 |
| transmission % | | | | | |
| (120 μm, 560 nm) | | | | | |
| Refractive index | 1.491 | 1.491 | 1.491 | 1.489 | 1.492 |
| (589 nm) | | | | | |
| Tg (C.) | 126 | 126 | 128 | 128 | 132 |
| Haze % | 0.3 | 0.5 | 0.3 | 0.4 | 0.3 |
| Vicat (C.) | | | | | |
| @10N | | | | | |
| Mw | 80,000 | 124,000 | 116,000 | 107,000 | 102,000 |
| Mw/Mn | 1.7 | 1.6 | 1.8 | 1.7 | 1.6 |

TABLE 3
Compositions and physical performance (continued)

| | Example 11B | Example 12B |
|---|---|---|
| | MW1908 | 2019-2-9 |
| Compositions | PMMA/t- | PMMA/ |
| | BCHMA | t-BCHMA |
| | 98.5/1.5 | (98.5/1.5) + |
| | | 35 weight % |
| | | Impact modifier |
| | | MPD85T |
| | | (Altuglas) |
| Trans/cis of | 86/14 | 86/14 |
| t-BCHMA | | |
| (or TMCHMA) | | |
| in copolymers | | |
| Syndiotacticity (rr) | 51 | 51 |
| isotaticity (mm) | 7 | 7 |
| Atacticity (rm) | 42 | 42 |
| MFR (g/10 min.) | 2.1 | 0.72 |
| Light | 92.3 | 91.6 |
| transmission % | | |
| (120 μm, 560 nm) | | |
| Refractive index | 1.491 | 1.491 |
| (589 nm) | | |
| Tg (° C.) | 119 | 118 |
| Haze % | 0.5 | 2.0 |
| Vicat (° C.) @10N | 118 | 117 |
| Mw | 105,000 | 104,000 |
| Mw/Mn | 2.0 | 1.9 |
| Tensile modulus | 3.1 | 2.0 |
| (GPa) | | |
| Tensile strength | 72 | 47 |
| (MPa) | | |
| Elongation (%) | 10 | 75 |
| Water absorption | 1.21 | 1.45 |
| (%) at 504 hours | | |
| Notched Izod impact | 2.1 | 4.8 |
| kJ/m² | | |

The results as summarized in Tables 1-3 demonstrate that including up to 20 weight % of at least one of tert-butyl cyclohexyl methacrylate, 3,3,5-trimethylcyclohexyl(meth)acrylate into an acrylic copolymers, such that at least 80 weight % of the comonomers is the trans isomer provides improved physical properties. As seen in the table, the improved properties are: a haze value of less than 2.5%, a light transmission value at 560 nm wavelength through a 120 μm film of at least 91%; a refractive index of from 1.47 to 1.50 at 589 nm wavelength; and a water absorption of less than 2 weight % after at least 504 hours in 60° C. water.

What is claimed is:

1. An acrylic copolymer comprising, as polymerized monomers:
a) from 0.2 to 20 weight percent of monomer units comprising at least one of tert-butyl cyclohexyl methacrylate, 3,3,5-trimethyl cyclohexyl (meth)acrylate, or a mixture thereof; wherein the monomer a) comprises at least 80 weight % trans isomer;
b) from 80 to 99.8 weight percent (meth)acrylate monomer units;
wherein the acrylic copolymer has:
i) a Tg of from 116° C. to 145° C., preferably from 120° C. to 145° C., more preferably from 125° C. to 145° C., and most preferably from 125° C. to 140° C.; and
ii) a weight average molecular weight (Mw) of at least 65,000 g/mole, preferably at least 75,000 g/mole, and more preferably at least 90,000 g/mole and most preferably at least 100,000 g/mol.

2. The acrylic copolymer of claim 1, wherein the acrylic copolymer has:
iii) a syndiotacticity (rr) of at least 50%.

3. The acrylic copolymer of claim 1, wherein the acrylic copolymer has the following properties:
iv) a haze value of less than 2.5%;
v) a light transmission value at 560 nm wavelength through a 120 μm film of at least 91%;
vi) a refractive index of from 1.47 to 1.50 at 589 nm wavelength; and
vii) a water absorption of less than 2 weight % after at least 504 hours in 60° C. water.

4. The acrylic copolymer of claim 1, wherein the copolymer comprises at least 51 weight % of methyl methacrylate monomer units.

5. The acrylic copolymer of claim 1, further comprising, as a polymerized monomer:
c) from 0.01 to 49.9 weight % of at least one additional monomer copolymerizable with monomer a) and b).

6. The acrylic copolymer of claim 5, wherein the additional monomer c) comprises at least one of methacrylic acid, acrylic acid, itaconic acid, alpha methyl styrene, maleic anhydride, maleimide, isobornyl methacrylate, norbornyl methacrylate, t-butyl methacrylate, cyclohexyl methacrylate, tetrahydrofurfuryl methacrylate, acrylamide and methacrylamide, or mixtures thereof.

7. The acrylic copolymer of claim 5, wherein the monomer c) is present as a polymerized monomer at from 0.01 to 25 weight % based on the weight of the acrylic copolymer.

8. A composition comprising the acrylic copolymer of claim 1.

9. The composition of claim 8 comprising from 100 to 2000 ppm weight of antioxidant comprising at least one of hydroxy phenyl benzotriazoles, sterically hindered phenolics, organo-phosphites, hindered amines, and combinations thereof.

10. The composition of claim 8, comprising from 5 to 60 weight % of impact modifier, based on total weight of the composition.

11. The composition of claim 10, wherein the impact modifier comprises at least one of a core-shell impact modifier, an acrylic block copolymer, a self-assembling, nanostructured polymer, or any combination thereof.

12. The composition of claim 10, wherein the impact modifier comprises a core-shell impact modifier.

13. The composition of claim 8, comprising at least one of poly(methyl methacrylate)/ethyl acrylate copolymer; poly(methyl methacrylate)/methyl acrylate copolymer; poly(methyl methacrylate)/methacrylate copolymer; poly(styreneacrylonitrile, SAN); polyvinylidene fluoride; copolymers of vinylidene fluoride and hexafluoropropene; polylactic acid; or combinations thereof.

14. The composition of claim 8, wherein the composition comprises one or more additives at an effective amount, comprising at least one of impact modifiers, fillers, surface modifying additives, processing aids, fibers, lubricant agents, matting agents, heat stabilizers, flame retardants, synergists, pigments or coloring agents.

15. The composition of claim 8, wherein the composition has the following properties:
iv) a haze value of less than 2.5%;
v) a light transmission value at 560 nm wavelength through a 120 μm film of at least 91%;
vi) a refractive index of from 1.47 to 1.50 at 589 nm wavelength; and
vii) a water absorption of less than 2 weight % after at least 504 hours in 60° C. water.

16. The composition of claim 8, wherein 3.2 mm thick samples of the composition have no visible stress crazing or cracking defects after 600 hours of exposure to 75 cycles of −40° C. to 80° C./85% RH.

17. An article comprising the acrylic copolymer of claim 1, wherein the article is at least one of electronic components in automotive front inner thick lenses, automotive interior thin lenses, smartphones, imaging lenses, photovoltaics, high heat LED diffusing sheets/films, digital printing with hydrophobic surfaces, (window) profiles, surface protection applications, automotive thin wall parts, medical devices, Li-ion battery binders electronic components, optical thin polarizers for LED/OLED displays, notebooks, and solar electronics.

18. An article comprising the composition of claim 8, wherein the article is at least one of electronic components in automotive front inner thick lenses, automotive interior thin lenses, smartphones, imaging lenses, photovoltaics, high heat LED diffusing sheets/films, digital printing with hydrophobic surfaces, (window) profiles, surface protection applications, automotive thin wall parts, medical devices, Li-ion battery binders, electronic components, optical thin polarizers for LED/OLED displays, notebooks, and solar electronics.
